(19) United States
(12) Patent Application Publication
(10) Pub. No.: US 2024/0160941 A1
(43) Pub. Date: May 16, 2024

(54) OPERATING DATA ANOMALY DETECTION AND REMEDIATION

(71) Applicant: Oracle International Corporation, Redwood Shores, CA (US)

(72) Inventors: Selim Necdet Mimaroglu, Arlington, VA (US); Anqi Shen, McLean, VA (US); Aniruddha Chauhan, Jersey City, NJ (US)

(73) Assignee: Oracle International Corporation, Redwood Shores, CA (US)

(21) Appl. No.: 18/069,534

(22) Filed: Dec. 21, 2022

Related U.S. Application Data
(60) Provisional application No. 63/383,176, filed on Nov. 10, 2022.

(51) Int. Cl. G06N 3/091; G06Q 30/0283

(52) U.S. Cl. CPC G06N 3/091; G06Q 30/0283; G01W 2001/006

(57) ABSTRACT

Techniques for detecting and remediating anomalous intervals in time-series data of a monitored device are disclosed. A system trains a machine learning model on a combination of real data obtained from a monitoring device and false data generated by adding noise to the real data. The model predicts operating values for the device at individual intervals of a time-series data set. The system identifies anomalies in the time-series data based on differences between the predicted values and the real values. If the difference between a predicted value generate by the machine learning model and the real value exceeds a threshold, the system identifies a particular data point, such as a meter reading, as anomalous. The system ranks anomalies to perform remediation operations based on the ranking.

### INCORPORATION BY REFERENCE; DISCLAIMER

This application claims the benefit of U.S. Provisional Patent Application 63/383,176, filed Nov. 10, 2022, which is hereby incorporated by reference. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to detecting and remediating anomalies detected in operating data. In particular, the present disclosure relates to training a machine learning model to predict target operating values for monitored devices to identify anomalies associated with the monitored devices.

### BACKGROUND

Remote system monitoring platforms monitor obtain system characteristics in real-time from sensors and analyze the sensor data to identify problems which may arise in the systems. One remote system monitoring platform is advanced metering infrastructure (AMI). AMI monitors an entity's utility usage using a utility meter. A transmitter transmits utility usage data to a utility provider. For example, a home equipped with an AMI power meter transmits power data to a power utility provider in real time or at regular intervals. The utility provider collects usage data for a particular time period to bill customers for their utility usage. In addition, utility providers may analyze usage data to identify usage requirements for customers and regions. Anomalies may occur in an AMI system as a result of theft, cyber-attacks, meter malfunctions, appliance or device malfunctions, data corruption, or other problems. Inaccurate usage data may result in inaccurate forecasting and customer billing.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrate a system in accordance with one or more embodiments;

FIG. 2A-2C illustrate an example set of operations for operation data anomaly detection and remediation in accordance with one or more embodiments;

FIGS. 3A and 3B illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. OPERATING DATA ANOMALY DETECTION AND REMEDIATION
4. EXAMPLE EMBODIMENT
5. COMPUTER NETWORKS AND CLOUD NETWORKS
6. MISCELLANEOUS; EXTENSIONS
7. HARDWARE OVERVIEW

### 1. General Overview

Utility providers collect utility usage data from meters to plan for load distribution, future modifications to utility networks, and bill clients for utility usage. However, many different events may cause disruptions to accurate utility monitoring, resulting in inaccurate planning and billing.

One or more embodiments include training a machine learning model on a combination of real data of a device and false data, generated by adding noise to the real data, to predict operating values for the device at individual intervals of a time-series data set. The system identifies anomalies in the time-series data based on differences between the predicted values and the real values. If the difference between a predicted value generated by the machine learning model and the real value exceeds a threshold, the system identifies a particular data point, such as a meter reading, as anomalous. The system ranks anomalies to perform remediation operations.

According to an example embodiment, a system trains a deep learning long short term memory (LSTM) encoder machine learning model to predict power usage values for intervals in a time-series set of data. The LSTM encoder ML model receives a set of time-series data as input data and predicts power usage levels for a device. A system may calculate anomaly values for each interval in the time series data. If the anomaly value exceeds the threshold, the system identifies the interval as anomalous. The system may rank anomalous intervals based on various criteria to determine an appropriate action for remediating an anomaly. According to one example, the system compares anomalous interval patterns with patterns associated with known issues, such as the installation of a new appliance in a home or a piece of equipment in a commercial or industrial environment. A pattern may be associated with theft, with a meter failure, or with an appliance or equipment failure. The system may rank anomalies according to the pattern the system associates with the anomaly. According to another example, the system ranks anomalies according to a severity of the anomaly. For example, if a real power usage value is 100% of a predicted power usage value, the system ranks the anomaly higher than another anomaly in which the real power usage value is 10% above a predicted power usage value.

One or more embodiments described in this Specification and/or recited in the claims may not be included in this General Overview section.

### 2. System Architecture

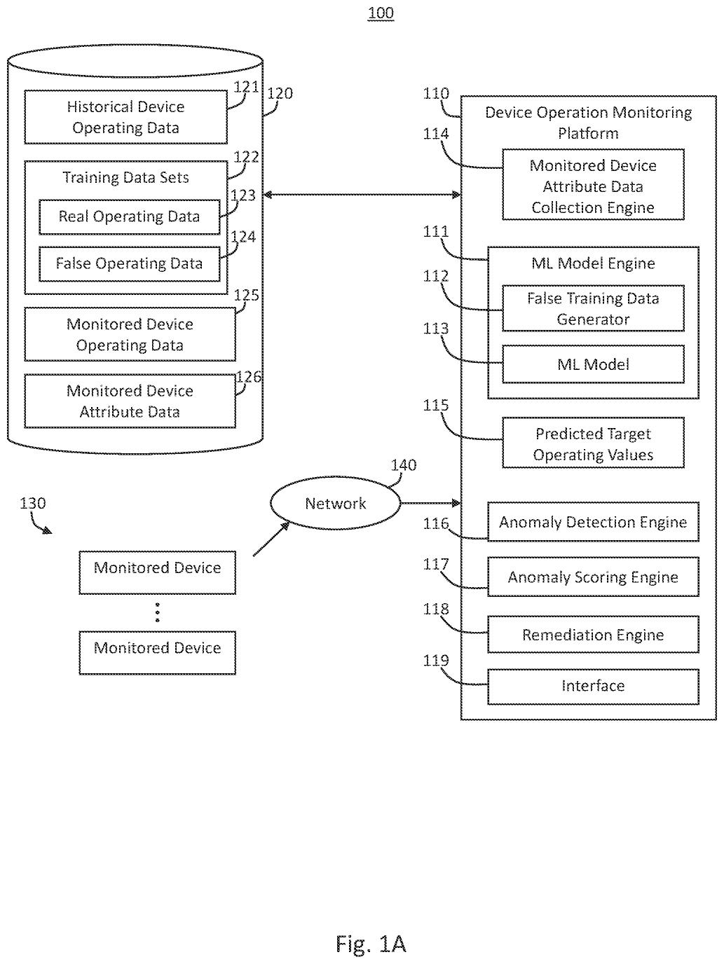

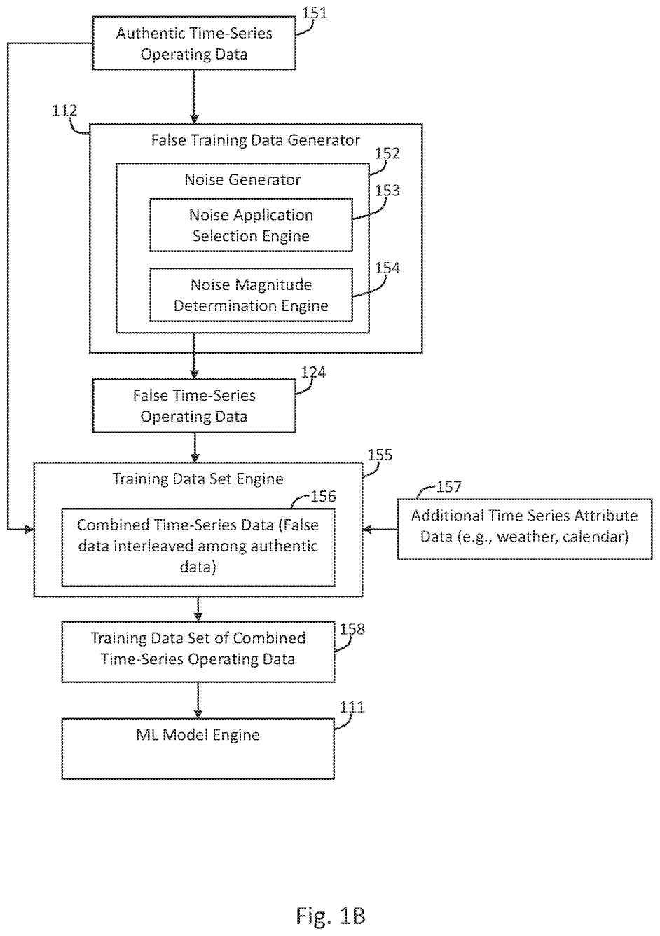

FIG. 1 illustrates a system 100 in accordance with one or more embodiments. As illustrated in FIG. 1, system 100 includes a device operation monitoring platform 110, a data repository 120, monitored devices 130, and a network 140. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The device operation monitoring platform 110 collects operating data from monitored devices 130 and stores the operating data as historical device operating data 121. The monitored devices 130 may include meters, such as utility meters. For example, the monitored devices 130 may be power meters that measure the amount of power used at a particular location, such as a home, a business, a farm, etc. The monitored devices 130 may transmit power usage data to the device operation monitoring platform 110 at regular intervals.

The device operation monitoring platform 110 includes a machine learning model engine 111. The machine learning model engine 111 is trained on training data sets 122 to predict target operating values for monitored devices 130. The machine learning model engine 111 generates a training data set of real operating data 123 from the historical device operating data. Each data point in a data set includes (a) a device operating value (such as an amount of usage within a defined interval of time), (b) attributes associated with the value, including a time interval associated with the value and weather conditions at the time the value was recorded, and (c) a label indicating the value corresponds to real operating data. The machine learning model engine 111 includes a false training data generator 112. The false training data generator 112 generates a set of false operating data 124 based on the real operating data 123 training data set. For example, the false training data generator 112 may randomly select a number of data points between 20% and 40% of the data points in the real operating data training data set 123. The false training data generator 112 adds noise to the selected data points to generate the false operating data training data set 124. The false training data generator 112 may add noise randomly, such as by randomly determining whether to add to or subtract from a usage value. In addition, the false training data generator 112 may add noise by randomly modifying a usage value of a data point between 5% and 500%. According to an example embodiment, the false training data generator 112 selects a cluster of sequentially-occurring time-series data points to which to add noise.

FIG. 1B illustrates the false training data generator 112 applied to an embodiment in which the data set is a time-series data set. The false training data generator 112 receives as input data authentic time-series operating data 151, which corresponds, for example, to the real operating data 123. A noise generator 152 adds noise to the authentic time-series operating data 151 to generate false time-series operating data 124, which corresponds to the false operating data 124 of FIG. 1A. The noise generator 152 includes a noise application selection engine 153 and a noise magnitude determination engine 154. The noise application selection engine 153 determines which data points, from among the data points of the authentic time-series operating data 151, to select for adding noise. The noise application selection engine 153 selects a particular number of data points according to a particular pattern. The particular number of data points may include, for example, a particular percentage of the authentic time-series operating data points. For example, if the authentic time-series operating data 151 includes 1,000 data points, the noise application selection engine 153 may select 10% of the data points for adding noise. In addition, the noise application selection engine 153 may add noise to the authentic time-series operating data 151 by removing data points from the operating data 151. For example, if the time-series data includes data points at time increments of one hour, the noise application selection engine 153 may remove the data point for a particular hour. According to one embodiment, the noise application selection engine 153 applies a randomization function to randomly select data points in the authentic time-series operating data 151 for adding noise until a termination condition is met. For example, the noise application selection engine 153 may select data points for adding noise according to the randomization function until 10% of the data points have been selected.

The noise magnitude determination engine 154 determines, for the selected data points, (a) a magnitude of noise to add to the data point and (b) a sign of the noise. The magnitude of noise may be either a percentage or an absolute value. For example, the noise magnitude determination engine 154 may apply a randomization function to randomly apply an amount of noise within a range from 20% to 500% of a value of a data point. Alternatively, in an example in which the data point represents a Kilowatt-hour, the noise magnitude determination engine 154 may randomly apply an amount of noise within a range of 0.5 kWh to 200 kWh. The noise magnitude determination engine 154 further determines whether to add the noise by applying a positive sign to the noise or a negative sign to the noise. According to one embodiment, the noise magnitude determination engine 154 applies a randomization function to determine whether to apply the positive or negative sign to the noise. For example, if a data point includes a value of 100, and if the noise magnitude determination engine 154 determines that noise with a magnitude of 75 will be added to the data point, the noise magnitude determination engine 154 may further randomly apply a positive sign to the noise, resulting in a data point value of 175, or a negative sign to the noise, resulting in a data point value of 25.

A training data set engine 155 creates a training data set 158 (corresponding to the combined training data set 122 of FIG. 1A) for training a machine learning model. The training data set engine 155 combines the authentic time-series operating data 151 with the false time-series operating data 124 to create the combined time-series data 156. The combined time-series data 156 includes the authentic time-series operating data 151 with selected data points replaced with false data points generated by the false training data generator 112. For example, if a segment of data includes hourly data points for a particular day, the false training data generator 112 may create false data points for the 10:00 AM data point and the 2:00 PM data point. The combined time-series data 156 includes the authentic data points for the day, from 12:00 AM to 9:00 AM, the false data point for 10:00 AM, the authentic data points for 11:00 AM to 1:00 PM, the false data point for 2:00 PM, and the authentic data points for 3:00 PM to 11:00 PM.

The training data set engine 155 further associates additional time series attribute data with the data points of the combined time-series data 156 to generate the training data set of combined time-series operating data 158. Examples of additional time series attribute data 157 include weather conditions associated with a set of operating data 151 and calendar information (such as a date or a particular event) associated with the set of operating data 151. The training data set engine 155 provides the training data set of combined time-series operating data 158 to the machine learning model engine 111 to train a machine learning model.

The machine learning model engine 111 trains a machine learning model 113 using the combined training data set 122 (corresponding to the training data set 158 in FIG. 1B) including both real operating data 123 and false operating data 124. The machine learning model engine 111 trains the machine learning model to identify relationships (a) between attributes within a same data point, and (b) between attributes of different data points in a same set of time-series data. According to one embodiment, the machine learning model is a deep learning long short-term memory (LSTM) autoencoder machine learning algorithm. The LSTM autoencoder machine learning algorithm is configured with sets of LSTM “cells.” Each “cell” includes a “cell state” and gates having parameters that are adjusted during training to teach the machine learning model relationships among data points in time series data. Each cell receives data via an input, outputs data via an output, and includes a “forget” gate. The input receives a data value associated with the present cell. For example, when the LSTM autoencoder algorithm is trained with time series data, one data point is associated with one cell and a subsequent time-series data point is associated with the subsequent cell. The input gate receives a data value associated with the present cell. The “forget” gate specifies a parameter which learns which information from a previous cell should be forgotten or disregarded. The autoencoder structure of the machine learning algorithm maps input data from a high-dimensional state to a low-dimensional state, and then back to the original high-dimensional state. According to one or more embodiments, the LSTM autoencoder machine learning model includes tens of thousands of parameters that are adjusted during training. For example, the LSTM autoencoder machine learning model may include between 60,000 and 70,000 parameters that are adjusted during training the machine learning model.

While an LSTM algorithm is described above by way of example, any machine learning model capable of processing time-series data as input data and identifying characteristics of particular intervals within the time series data may be utilized.

In some examples, one or more elements of the machine learning model engine 111 may use a machine learning algorithm to learn target operating data values for time-series data points. A machine learning algorithm is an algorithm that can be iterated to learn a target model f that best maps a set of input variables to an output variable, using a set of training data. A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In an embodiment, a set of training data includes datasets and associated labels. The datasets are associated with input variables (e.g., device operating values, time data, weather data, site data (e.g., single family residence, apartment, business, farm, factory, etc.) for the target model f. Each data point is associated with a label indicating the data point is real operating data or false operating data. Training the model involves auto-encoding an input vector representing the input data, reducing the dimensions within hidden layers of the model, and expanding the dimensions of the hidden layers of the model such that a number of dimensions of the output layer is the same as the input layer. Training the model involves adjusting parameters to result in the values at the output layer being the same as the values at the input layer. The training data may be updated based on, for example, feedback on the accuracy of the current target model f. Updated training data is fed back into the machine learning algorithm, which in turn updates the target model f.

A machine learning algorithm generates a target model f such that the target model f best fits the datasets of training data to the labels of the training data. Additionally, or alternatively, a machine learning algorithm generates a target model f such that when the target model f is applied to the datasets of the training data, a maximum number of results determined by the target model f matches the labels of the training data.

In an embodiment, a machine learning algorithm can be iterated to predict device operating values for time-intervals in time-series data. In an embodiment, a set of training data includes real operating data 123 and false operating data 124. The training data sets 122 are associated with labels, indicating whether a particular data point in the training data set corresponds to real operating data or false operating data.

The device operation monitoring platform 110 receives operating data 125 from a monitored device 130. For example, a utility provider may receive real-time, minute-by-minute, hourly, or daily updates from a power meter regarding power usage measured by the meter. Upon receiving operating data 125, a monitored device attribute data collection engine 114 collects additional attribute data 126 associated with the monitored device. For example, the monitored device attribute data collection engine 114 may identify a weather station nearest to the device 130 generating the operating data. The device operation monitoring platform 110 may store the weather data together with the received operating data value for a particular time interval. Other examples of attribute data which may be stored with an operating data value as a data point include supplemental utility data, such as whether a location includes an alternative power generator. Attribute data may include information about a type of structure associated with the meter, such as a single family home, an apartment, a hotel, an industrial site, a farm, a factory, a warehouse, or a storefront. The attribute data may include a size of a structure associated with the meter, such as a number of bedrooms in a home or the square-footage of the structure.

The machine learning model engine 111 embeds the monitored device operating data 125 and attribute data 126 as vectors of a set of time-series data. The machine learning model engine 111 feeds the time-series data to the machine learning model 113 to generate predicted target operating values 115 for each sub-interval within the time-series data. For example, a set of time-series data may include 30 days of power data, divided into 30 sub-intervals, each corresponding to power usage and additional attributes for each of the 30 days.

An anomaly detection engine 116 analyzes the predicted target operating values 115 to detect anomalies among the sub-intervals in the time-series data. The anomaly detection engine 116 identifies data points, corresponding to the sub-intervals of time within the set of time-series data, that have anomalous values. In particular, the machine learning model 113 generates predicted target values for the data points in the time series data, based on the learned correlations (a) between attributes within a data point, and (b) between attributes of different data points in time-series data. The anomaly detection engine 116 compares the predicted target operating values 115 to the actual values of the monitored device operating data 125. The anomaly detection engine 116 calculates an anomaly score for each data point in the time-series data set based on the difference between the predicted target value for the data point and the actual value associated with the data point. If the difference between the predicted target values and the actual values exceeds a threshold, the system identifies a particular data point as being anomalous.

An anomaly scoring engine 117 analyzes the anomalous data points in time-series data to assign a ranking or a weight to the anomalous data points. For example, the anomaly scoring engine 117 may assign a relatively greater weight to a data point having higher anomaly score than to a data point having a lower anomaly score. Alternatively, the anomaly scoring engine 117 may assign a greater rank or weight to a cluster of data points that include a particular pattern. The anomaly scoring engine 117 may identify patterns associated with meter failure, appliance failure, utility theft, utility transmission failure, and data transmission failure. The anomaly scoring engine 117 may assign different ranking values to different identified patterns based on a severity of the corresponding failure.

A remediation engine 118 selects a remedial action to perform associated with a detected anomaly in a set of time-series data. Examples of remediation operations include generating notifications to customers and/or utility providers, remotely resetting a meter, and adjusting a value calculation for a customer's utility bill. The remediation engine 118 may select the remedial action according to the ranking or weight of the detected anomaly. For example, if the system detects in a set of time-series data an anomaly associated with a data transmission failure which has been resolved, the system may refrain from performing further remedial action. If the system detects in the set of time-series data an anomaly associated with a utility transmission failure, the system may trigger a notification to a utility service provider that a repair may be required.

Additional embodiments and/or examples relating to computer networks are described below in Section 5, titled “Computer Networks and Cloud Networks.”

In one or more embodiments, a data repository 120 is any type of storage unit and/or device (e.g., a file system, database, collection of tables, or any other storage mechanism) for storing data. Further, a data repository 120 may include multiple different storage units and/or devices. The multiple different storage units and/or devices may or may not be of the same type or located at the same physical site. Further, a data repository 120 may be implemented or may execute on the same computing system as the device operation monitoring platform 110. Alternatively, or additionally, a data repository 120 may be implemented or executed on a computing system separate from the device operation monitoring platform 110. A data repository 104 may be communicatively coupled to the device operation monitoring platform 110 via a direct connection or via a network.

Information describing training data sets, monitored device operating data, and monitored device attribute data may be implemented across any of components within the system 100. However, this information is illustrated within the data repository 120 for purposes of clarity and explanation.

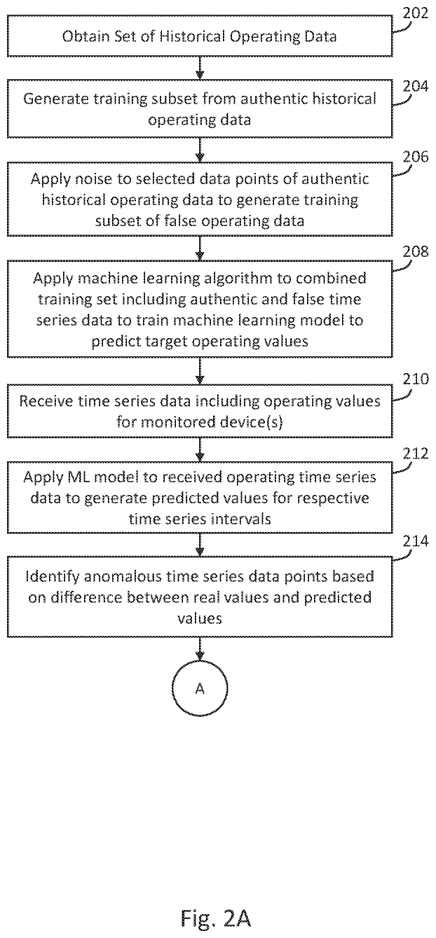

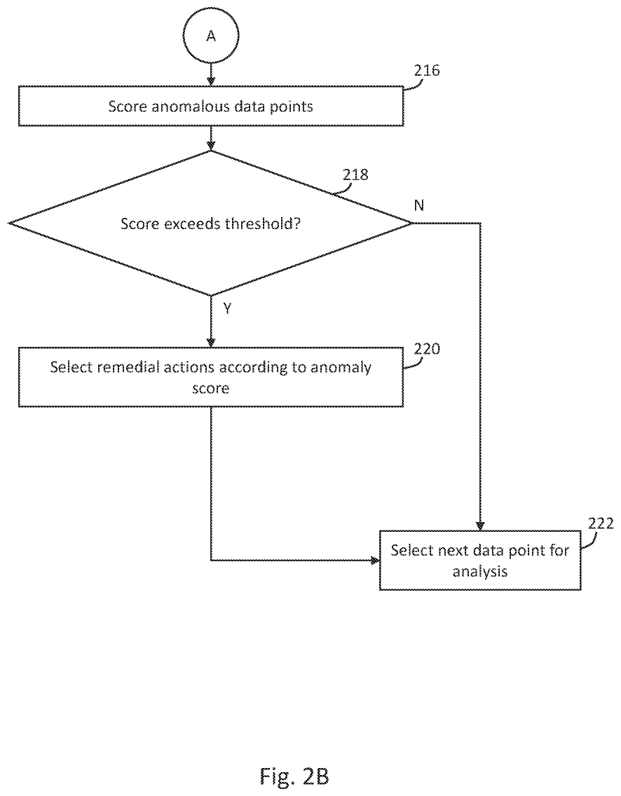

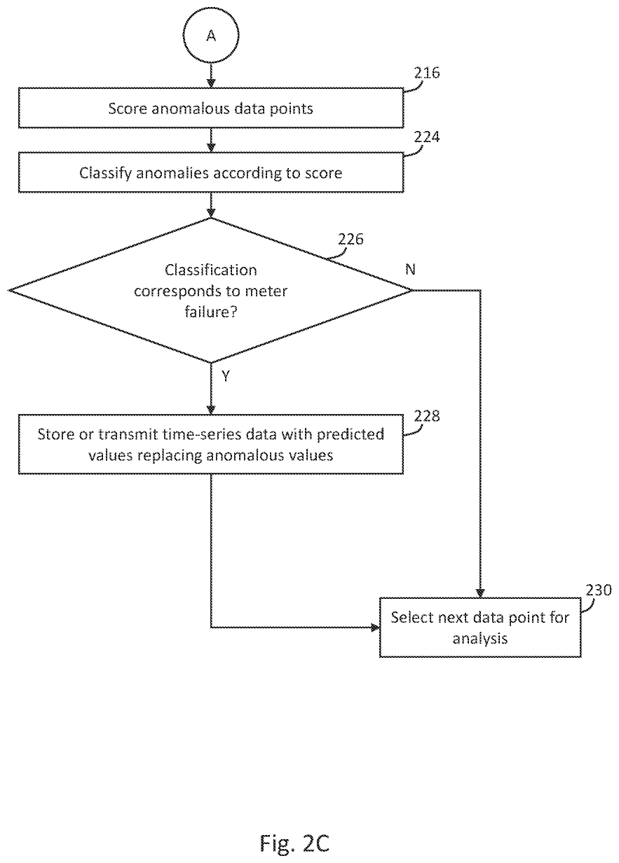

In one or more embodiments, a device operation monitoring platform 110 refers to hardware and/or software configured to perform operations described herein for collecting operating data, analyzing the operating data by applying a trained machine learning model to the operating data, and identifying and remediating anomalies in a system using the predictions generated by the trained machine learning model. Examples of operations for identifying and remediating anomalies based on monitored device operating data are described below with reference to FIGS. 2A-2C.

In an embodiment, the device operation monitoring platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, interface 119 refers to hardware and/or software configured to facilitate communications between a user and the device operation monitoring platform 110. Interface 119 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 119 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 119 is specified in one or more other languages, such as Java, C, or C++.

### 3. Identifying and Remediating Anomalies Based on Operation Data

FIGS. 2A-2C illustrate an example set of operations for identifying and remediating anomalies based on operation data in accordance with one or more embodiments. One or more operations illustrated in FIGS. 2A-2C may be modified, rearranged, or omitted all together. Accordingly, the particular sequence of operations illustrated in FIGS. 2A-2C should not be construed as limiting the scope of one or more embodiments.

A system obtains a set of historical data (Operation 202). The historical data includes operating data values and attributes associated with the operation of one or more monitored devices. Examples of operating data values include power or other utility usage levels and calendar data, such as a timestamp associated with usage levels. Examples of attributes associated with the operating data values include weather data, location data, data describing a type of facility or structure utilizing a utility (e.g., commercial, retail, industrial), data describing a size of the structure, such as a number of bedrooms, rooms, or square footage, data describing how the structure is used (e.g., private home, hotel, data center, farmland, factory, storefront, warehouse) and data specifying whether a location is associated with relevant features, such as solar panels, wind turbine, or a pool.

The system generates a training data set from the historical operating data (Operation 204). The training data set includes data points specifying operating data values and attributes associated with monitored devices generating the operating values. For example, a data point may include a kWh power consumption over the course of an hour and weather at a location associated with a meter generating the kWh power consumption value.

The system generates a training data set of false operating data using the training data set of real historical operating data (Operation 204). The system selects data points from among the training subset of real historical operating data. The system introduces noise into the selected data points to generate a data set of false operating data. For example, the system may copy the training data set of real operating data and introduce noise into each copy. Alternatively, the system may select a predetermined number of data points from the training data set, such as 50%, to copy and introduce noise to generate the training data set of false operating values. According to yet another alternative, the system iteratively performs a process of (a) selecting real historical operation data, (b) generating false operation data by adding noise, (c) applying a machine learning algorithm to the combined data, (d) determining an accuracy of the machine learning model obtained by applying the algorithm to the combined data set, and (e) if the accuracy of the predictions is less than a threshold, repeating (a)-(d).

According to an example embodiment, the system replaces, in time-series data, a random number of data points with false data points including noise. For example, in a time-series data set including 30 time-series data points, the system may replace 10 data points, located at random among the 30 time-series data points, with false data points including noise. In addition, or in the alternative, the false data points may be introduced to the data set in clusters. For example, in a data set including 30 time-series data points, the system may introduce the false data points in three sets: 3 time-series data points, 3 time-series data points, and 4 time-series data points. The sets may comprise consecutive time-series data points. The system may calculate the noise to add to the cluster according to a randomizing formula. For example, the noise values in each of the data points in a cluster may be random, within a predetermined range. Alternatively, the noise values in each of the data points in a cluster may be random in magnitude, but with a same positive or negative sign. In other words, while the system may add or subtract a value from real operating values to obtain a false operating value, each data point in one cluster will add a value to create noise. Each data point in another cluster will subtract a value to add noise.

According to one or more embodiments, the system may add the noise to a cluster in a particular pattern. For example, the system may randomly determine a particular cluster of 3 time-series data points will receive a positive noise operating value of 10 kWh, where 10 kWh is a value randomly selected from a range of values between 1 kWh and 50 kWh. The system may select one of the 3 time-series data points to have an operating value of 10 kWh. The system may apply a gradation formula to set the operating values for the other 2 data points. For example, the system may apply a formula that sets noise values adjacent to a peak, randomized noise value, at 10% less in magnitude from the peak, randomized operating value. Alternatively, the system may add noise to a cluster by applying a Bell curve formula.

According to one or more embodiments, adding noise to time-series data points includes: (a) selecting a number of data points within a time-series data set to which to add noise, (b) selecting whether to add noise by increasing a magnitude of an operating value of a data point or decreasing the magnitude of the operating value of the data point, (c) selecting the magnitude with which to increase/decrease the operating value. The system may select the number of data points within the time-series data set to which noise will be added randomly. For example, if a particular time-series data set includes 360 data points, the system may randomly select data points from among the 360 data points to which to add noise. Alternatively, the system may randomly select data points within a threshold number of data points. For example, the system may apply a formula that calculates a value between 20% and 50% of the data points in a data set to add noise. If a particular time-series data set includes 360 data points, the system may randomly select a number of data points within a range of 72 to 180 from among the 360 data points to which to add noise. Selecting the number of data points within the time-series data set to which to add noise may include adding noise to a random distribution of sites (i.e., operating data value generators, such as meters) from among the sites providing data that makes up the data set. For example, the system may apply a rule to add noise to time-series data from a random selection of 20% of the sites providing data that make up the data set. According to one or more embodiments, the system adds noise to data points in a data set according to particular distributions, such as: a Poisson distribution, an F-distribution, a Chi-squared distribution, a Student's t-distribution, a Normal distribution, and a Uniform distribution.

Selecting whether to increase or decrease a magnitude of an operating value of a data point may be randomized, such that any particular data point has a 50% chance of an increased operating value magnitude and a 50% chance of a decreased operating value magnitude.

Selecting the magnitude with which to increase or decrease an operating value to add noise may be random, within a particular range of values. For example, the system may apply a formula that specifies an operating value should be selected randomly within a range of operating values that varies between 5% and 500% of the real operating value of the historical data point. In addition, or in the alternative, the system may apply a rule to change a magnitude of operating data values by a particular range of units. For example, if the data set includes power data measured in kilowatt hours (kWh), the system may apply a rule to add/subtract between 1 kWh and 10 kWh to data points to which noise is being added.

According to one or more embodiments, the system trains the machine learning model using operating data values from multiple sites over a particular period of time. For example, a training data set may include power usage data from 300 separate power meters associated respectively with 300 separate sites, such as residences. The training data set may include time-series data spanning weeks, months, or years. For example, a training data set for training a machine learning model to identify anomalous values in one-month segments of time-series data divided into daily intervals may span multiple different sites over two or more years. The system may add noise to data points within a particular date range within the training data set, or across the entire date range of the entire training data set.

The system applies a machine learning algorithm to the combined training set to train a machine learning model to predict target operating values (Operation 208). According to one embodiment, the machine learning algorithm accepts as input data time series data obtained over a specified period of time. The period of time of a time-series segment provided to the machine learning algorithm is separated into incremental intervals. Each interval has its own operating data value and its own additional attributes. For example, the algorithm may accept as input data a time-series segment comprising 30 days of data points. Each data point specifies an amount of power in kWh consumed on the particular day, a weather state associated with the particular day, and any additional attributes included in the time series data. Based on the relationships (a) between attributes within a particular data point and (b) attributes between different data points in the same time-series segment, the system adjusts parameters of the machine learning algorithm to train a machine learning model.

According to one embodiment, the machine learning algorithm is a deep learning long short-term memory (LSTM) autoencoder machine learning algorithm. The LSTM autoencoder machine learning algorithm is configured with sets of LSTM “cells.” Each “cell” includes a “cell state” and gates having parameters that are adjusted during training to teach the machine learning model relationships among data points in time series data. Each cell receives data via an input, outputs data via an output, and includes a “forget” gate. The input receives a data value associated with the present cell. For example, when the LSTM autoencoder algorithm is trained with time series data, one data point is associated with one cell and a subsequent time-series data point is associated with the subsequent cell. The input gate receives a data value associated with the present cell. The “forget” gate specifies a parameter which learns which information from a previous cell should be forgotten or disregarded. The autoencoder structure of the machine learning algorithm maps input data from a high-dimensional state to a low-dimensional state, and then back to the original high-dimensional state. According to one or more embodiments, the LSTM autoencoder machine learning model includes tens of thousands of parameters that are adjusted during training. For example, the LSTM autoencoder machine learning model may include between 60,000 and 70,000 parameters that are adjusted during training the machine learning model.

While an LSTM algorithm is described above by way of example, any machine learning model capable of processing time-series data as input data and identifying characteristics of particular intervals within the time series data may be utilized.

The system receives time series data including operating values from one or more monitored devices (Operation 210). For example, the system may obtain power-consumption data generated by a power meter associated with a residence. According to another example, the system may obtain water-consumption data generated by a water meter associated with an industrial facility. The system may obtain the data in real-time, as the data is generated. Alternatively, the system may request or upload data in batches, such as in daily intervals, weekly intervals, or monthly intervals.

The system applies the trained machine learning model to the time-series data to generate predicted values for the intervals in the time-series data (Operation 212). In particular, the system provides as input data to a machine learning model engine storing and running a machine learning model, a set of time-series data spanning a particular period of time. The time-series data includes intervals of time within the period of time. For example, the period of time may be a week, a month, or multiple months. The intervals of time may be minutes, hours, or days, for example. The system identifies data points, corresponding to intervals of time within the set of time-series data, that have anomalous values. In particular, the machine learning model generates predicted target values for the data points in the time series data, based on the learned correlations (a) between attributes within a data point, and (b) between attributes of different data points in time-series data.

The system identifies anomalous data points within the time series data (Operation 214). For each data point associated with an interval of the time series data, the system compares the predicted target value generated by the machine learning model based on analyzing multiple data points of the time series data to the actual value of the interval in the time-series data. The system calculates an anomaly score for each data point in the time-series data set based on the difference between the predicted target value for the data point and the actual value associated with the data point. In other words, the more the actual operating data value for a data point differs from the predicted target operating value, the greater the anomaly score. If the difference between the predicted target values and the actual values exceeds a threshold, the system identifies a particular data point as being anomalous.

Referring to FIG. 2B, the system analyzes the anomalous data points in time-series data to assign an anomaly score or a weight to the anomalous data points (Operation 216). For example, the system may assign a relatively greater weight to a data point having higher anomaly score than to a data point having a lower anomaly score. Alternatively, the system may assign a greater weight to a cluster of data points that include a particular pattern. The system may store utility usage patterns associated with particular events, such as meter failure, appliance failure, utility theft, and transmission failure (such as a broken water supply pipe, in the case of a water utility, or a shorted power supply line, in the case of a power utility). As an example, the system may identify a pattern of power usage dropping to a steady, low usage rate independent of weather conditions as an anomaly associated with a data transmission failure from solar panels installed on a structure. The system may assign different ranking values to different identified patterns of anomalous data points based on a severity of the corresponding failure. A detected anomaly corresponding to a pattern associated with a failed data transmission may receive a lower ranking than an anomaly corresponding to a pattern associated with a damaged power line.

The system determines whether anomaly scores exceed a threshold (Operation 218). The threshold may include one or both of (a) a threshold difference between a predicted value for a data point and the actual value for the data point, and (b) a threshold number of data points within a set of data points that is anomalous. For example, the threshold may specify 50% or more of a set of 20 data points being anomalous by more than 10% of predicted values. A data set in which 40% of the data points were anomalous by more than 10% of predicted values would not meet the threshold. The threshold may include multiple tiers. For example, the threshold may specify (a) 50% or more of a set of 20 data points being anomalous by more than 10% of predicted values, or (b) 10% or more of a set of 20 data points being anomalous by more than 30% of predicted values. In other words, the threshold may be set to define a sliding scale requiring more anomalous data points of lower severity or fewer anomalous data points of higher severity.

If an anomalous data point or set of data points exceeds a threshold, the system selects a remedial action to perform associated with a detected anomaly in a set of time-series data (Operation 220). The system may select the remedial action according to the ranking or weight of the detected anomaly. For example, if the system detects in a set of time-series data an anomaly associated with a data transmission failure which has been resolved, the system may refrain from performing further remedial action. If the system detects in the set of time-series data an anomaly associated with a utility transmission failure, the system may trigger a notification to a utility service provider that a repair may be required. According to one example embodiment, the system analyzes utility usage for a particular billing period to determine whether an amount billed to a customer is accurate. If the system detects within time-series data for a billing period an anomaly with a pattern associated with the theft of the utility (such as an unauthorized use of power from a particular location), the system may generate a notification to the customer suggesting the customer review a charge. In addition, or in the alternative, the system may refrain from including in a customer's bill charges associated with the anomalous usage.

If the system determines that an anomalous data point or set of anomalous data points does not exceed a threshold, the system selects the next data point corresponding to the next interval of time in a set of time-series data, for analysis (Operation 222).

FIG. 2C illustrates a set of operations that may be performed in addition to, or alternatively to, the set of operations illustrated in FIG. 2B.

Similar to FIG. 2B, as discussed above, the system analyzes anomalous data points to generate scores and/or weights associated with the anomalous data points (Operation 216).

Based on one or more scores in a set of time-series data, the system classifies anomalies (Operation 224). For example, the system may classify a set of anomalous scores for data points in a set of time-series data as: meter failure, appliance failure, solar panel failure, utility theft, new appliance installation, utility provider failure, data transmission error, and increase/decrease in utility usage associated with increase/decrease in occupants in a dwelling or change in operations at a business facility.

The system determines whether an anomaly classification corresponds to a meter failure (Operation 226). If a classification does not correspond to a meter failure, the system selects a next data point for analysis (Operation 230). If the classification corresponds to a meter failure, the system stores or transmits the predicted value(s) for time-series interval data points corresponding to the meter failure instead of the measured values for the time-series interval data points corresponding to the meter failure. For example, the system may detect a meter failure for two days out of thirty days. Instead of, or in addition to, storing the measured values for the two days, the system stores predicted values generated by the machine learning model. According to one example embodiment, remedial action includes sending a notification to a service center regarding a meter failure. Operators may contact a customer to check a meter, or to schedule a time for servicing the meter. According to another example embodiment, a bill that displays utility usage at different time intervals over a set period of time (such as daily power usage over the course of a month) may display actual measured usage values that are anomalous as dashed lines and predicted usage values for the same time intervals overlaid on top of the actual measured usage values.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

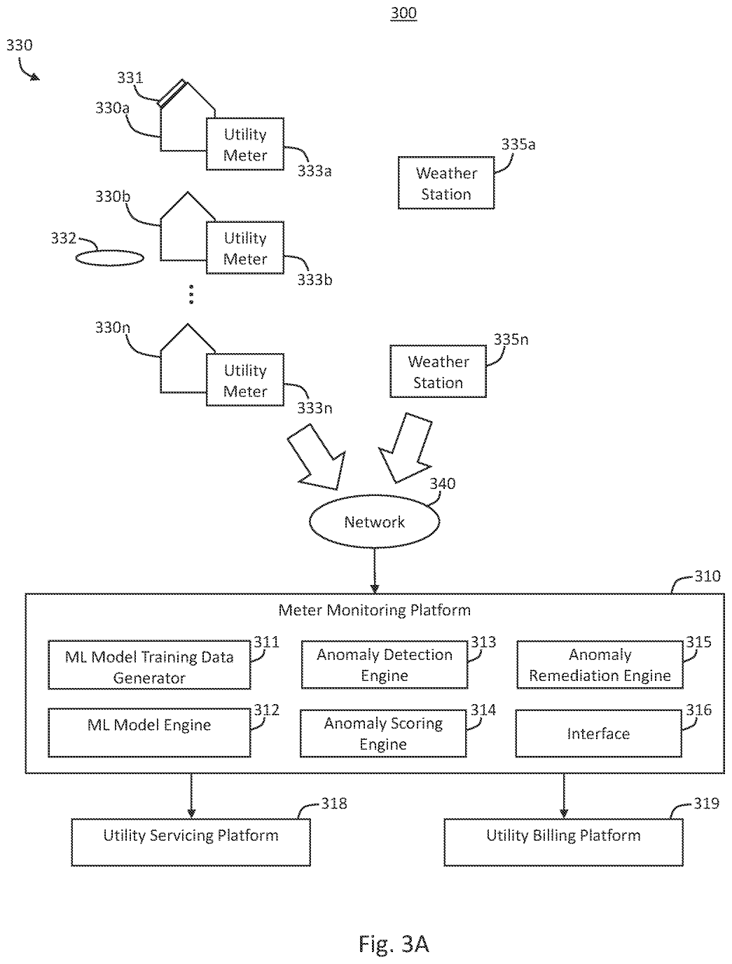

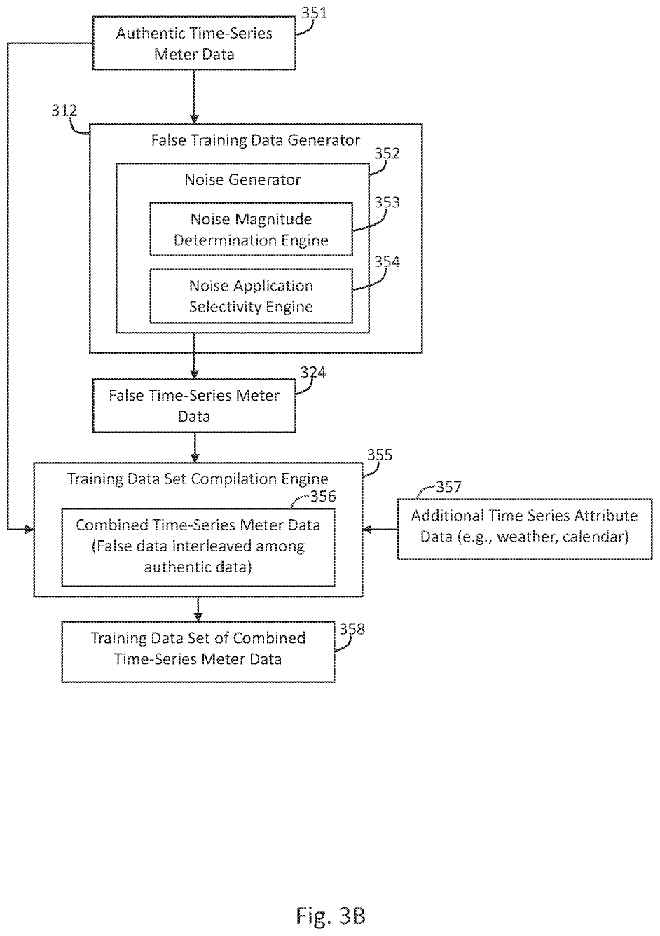

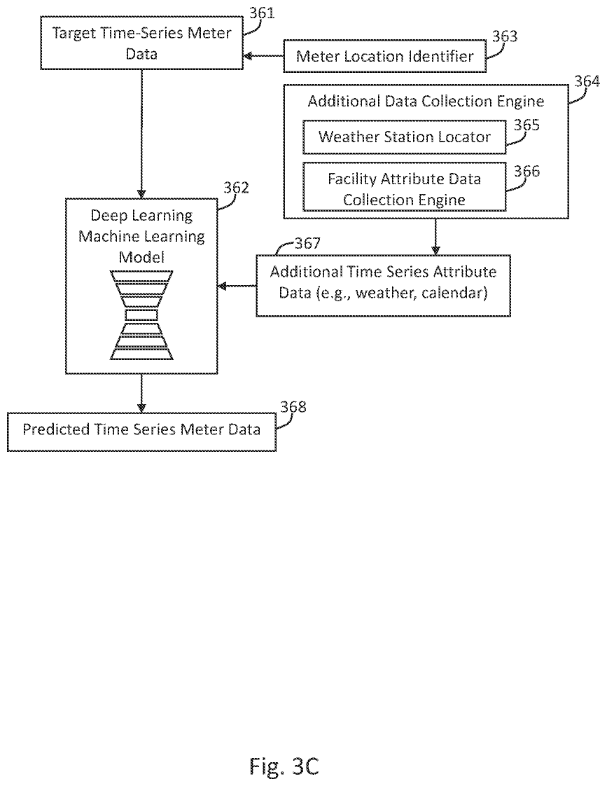

FIG. 3A illustrates a system 300 for monitoring power usage using Advanced Metering Infrastructure (AMI) technology. The system 300 includes dwellings 330a-330n. The dwellings 330a-330n are connected to a power utility network. Power usage at the dwellings 330a-330n is monitored by meters 333a-333n. The meters 333a-333n transmit power usage data to a meter monitoring platform 310 via a network 340. The network may include a global data network such as the Internet.

A machine learning model training data generator 311 generates a training data set comprised of authentic time-series data obtained from the dwellings 330 and false time-series data. As illustrated in FIG. 3B, the machine learning model training data generator 311 obtains authentic time-series meter data 351 from the dwellings 330 and provides the authentic time-series meter data 351 to a false training data generator 312.

A noise generator 352 adds noise to the authentic time-series meter data 351 to generate false time-series meter data 324. The noise generator 352 includes a noise application selection engine 353 and a noise magnitude determination engine 354. The noise application selection engine 353 determines which data points, from among the data points of the authentic time-series meter data 351, to select for adding noise. The noise application selection engine 353 selects a particular number of data points according to a particular pattern. The particular number of data points includes a particular percentage of the authentic time-series operating data points. In the example embodiment illustrated in FIG. 3B, the authentic time-series meter data 351 includes one month of meter data divided into one hour increments. Each increment includes (a) a value corresponding to an amount of power consumed, as measured by a corresponding utility meter, within the respective hour, and (b) a timestamp indicating the hour and date in which the power consumption was measured by the meter. The noise application selection engine 353 selects 20% of the data points in a set of authentic time-series meter data 351, or approximately (depending on the number of days in a given month) 144 data points corresponding to 144 hours within a 720-hour 30-day month. The noise application selection engine 353 further removes 5% of the data points, or approximately 36 data points corresponding to 36 hours within a 720-hour 30-day month, in the set of authentic time-series meter data 351. According to one embodiment, the noise application selection engine 353 applies a randomization function to randomly select data points in the authentic time-series operating data 351 for adding noise until a termination condition is met. For example, the noise application selection engine 353 may randomly select data points corresponding to hour-increments among the 720 hour-increments of the authentic time-series meter data 351 until 144 data points have been selected.

The noise magnitude determination engine 354 determines, for the selected data points, (a) a magnitude of noise to add to the data point and (b) a sign of the noise. The magnitude of noise may be either a percentage or an absolute value. In the example illustrated in FIG. 3B, the noise magnitude determination engine generates a random value between 20%-100% of a magnitude of a power usage value for a data point. In addition, the noise magnitude determination engine 354 further randomly applies a positive sign or a negative sign to the random value.

A training data set compilation engine 355 creates a training data set 358 of combined time-series meter data for training a machine learning model. The training data set compilation engine 355 combines the authentic time-series operating data 351 with the false time-series operating data 324 to create the combined time-series data 356. The combined time-series data 356 includes the authentic time-series operating data 351 with selected data points replaced with false data points generated by the false training data generator 312.

The training data set compilation engine 355 further retrieves additional time series attribute data with the data points of the combined time-series data 356 to generate the training data set of combined time-series operating data 358. The additional time series attribute data 357 includes weather conditions at times corresponding to the timestamps of the authentic time-series meter data 351 and calendar information associated with the timestamps of the authentic time-series meter data 351.

The meter monitoring platform 310 provides the training data set of combined time-series operating data 358 to the machine learning model engine 312 to train a machine learning model 362 to predict target operating values for meters. The machine learning model may be applied to time-series data generated by one of the meters 333a-333n, or to another meter determined to have characteristics similar to the meters 333a-333n. For example, the meter monitoring platform 310 may apply the machine learning model to any meters within a specified geographic region and associated with single family dwellings.

The machine learning model engine 311 trains the machine learning model 362 to identify relationships (a) between attributes within a same data point, and (b) between attributes of different data points in a same set of time-series data. In the example illustrated in FIGS. 3A and 3C, the machine learning model 362 is a deep learning long short-term memory (LSTM) autoencoder machine learning model.

Upon training the machine learning model 362, the meter monitoring platform 310 obtains target time-series meter data 361, as illustrated in FIG. 3C. The target time-series meter data 361 is data generated by one power meter, such as the power meter 333a of the dwelling 330a. The meter 333a associated with the target time-series meter data 361 may be among the set of meters providing data for training the machine learning model 362. Alternatively, the meter 333a may not have been among the set of meters used to train the machine learning model 362.

The target time-series meter data 361 may be Net Advanced Metering Infrastructure (AMI) data. Net AMI data includes values that reflect not only power supplied to a customer from a utility supplier, but also power generated by the customer, such as by solar panels 331. For example, in some solar systems, solar panels do not power the dwelling on which they are mounted. Instead, a utility company provides all power to the dwelling, the solar panels feed electricity back into the power grid, and the utility company deducts the cost of the electricity from a utility bill associated with the dwelling. The target time-series meter data 361 may include meter values that include power provided from a utility provider minus power generated by solar panels and sold back to the utility provider. While solar panels are described in the example embodiment associated with FIG. 3A, additional power sources that generate power at a dwelling that may be sold to a utility company include wind turbines and geothermal generators.

The target time-series meter data 361 corresponds to a duration of one month. The target time-series meter data 361 includes separate data points for each hour-interval within the one month period of time. For example, if the month is 30 days, the target time-series data 361 includes 720 separate data points, each data point including (a) a meter value (e.g., power consumed in kWh), (b) a timestamp, and (c) additional attribute data 367, such as weather data or attribute data about the monitored location (such as that the dwelling 330a includes solar panels 331, or that the dwelling 330b includes a pool 332).

In the embodiment illustrated in FIG. 3C, a meter location identifier 363 determines a location of a meter generating the target time-series meter data 361. The location may be an address, coordinates, or a region. The additional data collection engine 364 includes a weather station locator 365 to located a weather station 335a or 335n in the vicinity of the meter location. The weather station may be the closest weather station to the meter generating the target time-series meter data 361. The facility attribute data collection engine 366 collects additional data about the facility being monitored by the meter, including unique power-consumption properties. For example, the facility attribute data collection engine 366 may determine whether the residence 330a includes solar panels 331, a pool, is associated with a high-power-consuming operation, such as a data center, or is a multi-residence building.

The meter monitoring platform 310 provides the target time-series meter data 361 and the additional time series attribute data 367 to the machine learning model 362 to generate, for each data point of the target time-series meter data 361, a power usage predicted value. The set of predicted values for the target time-series meter data 361 is the predicted time series meter data 368.

An anomaly detection engine 313 analyzes the predicted time-series meter data 368 to detect anomalies among the intervals in the data. The anomaly detection engine 313 identifies data points, corresponding to hours of time within the month time period, that have anomalous values. An anomaly scoring engine 314 calculates an anomaly score for each data point in the time-series data set based on the difference between the predicted target value for the data point and the actual value associated with the data point. If the difference between the predicted target values and the actual values exceeds a threshold, the system identifies a particular data point as being anomalous. A higher difference between a predicted meter value and a measured meter value corresponds to a higher anomaly score. A lower difference between a predicted meter value and a measured meter value corresponds to a lower anomaly score.

An anomaly remediation engine 315 selects a remedial action to perform associated with a detected anomaly in the target time-series meter data 361. Examples of remediation operations include generating notifications to customers and/or utility providers, remotely resetting a meter, and adjusting a value calculation for a customer's utility bill.

The system 300 includes a utility servicing platform 318. Based on detecting an anomaly score exceeding a threshold, the anomaly remediation engine 315 may transmit data associated with the anomaly to the utility servicing platform 318. For example, the anomaly remediation engine 315 may detect a power usage pattern in the target time-series meter data 361 that corresponds to power theft. The meter monitoring platform 310 sends location data associated with the meter 333a and the potential theft to the utility servicing platform 318. The utility servicing platform 318 generates a ticket. A utility worker may inspect the meter associated with the ticket to determine whether theft is occurring, or whether any other fault or issue may be observed at the meter 333a.

The system 300 includes a utility billing platform 319. The utility billing platform 319 utilizes the machine learning model 362 analysis of the target time-series meter data 361 to determine whether an amount billed to a customer is accurate. Throughout a billing period, such as a particular month, the meter 333n transmits net AMI utility usage data to a meter monitoring platform 310 maintained by a utility provider. The utility provider stores the utility usage data in a data repository. The meter monitoring platform compiles the Net AMI time-series meter data for a particular billing period from the data repository prior to sending a bill to a customer. The meter monitoring platform 310 applies the model 362 to the Net AMI time-series meter data for the month to identify particular days and hours that have anomalous usage values. The utility billing platform 319 initiates remediation actions according to a severity of the anomalous usage values. For example, the utility billing platform 319 may generate a notification to a customer if an anomaly is associated with a low ranking or severity. The utility billing platform 319 may generate a warning to a theft-prevention unit if an anomaly ranking corresponds to potential theft of the utility. The utility billing platform 319 may prompt a utility representative to omit charges for one or more days from a bill to a customer pending review of the charges if an anomaly ranking is associated with a meter failure.

While the embodiment described in FIGS. 3A-3C has been described in terms of a set of time-series data corresponding to a month-duration in hourly intervals, embodiments include different durations for sets of time-series data and different intervals. For example, according to one example embodiment, the meter monitoring platform 310 analyzes utility usage data from a meter to identify equipment failures and data transmission failures. The meter monitoring platform 310 may analyze utility usage data received from utility meters in real-time or in near real-time. For example, a machine learning model 362 may be trained to receive as input data a one-week segment of time-series data made up of one-hour intervals as separate data points within the one-week segment of time-series data. Each day, the meter monitoring platform 310 may provide to the machine learning model the previous seven days of utility usage data. The machine learning model 362 generates, for each hour-interval in the one-week segment of time-series data, a prediction of a target utility usage value. The meter monitoring platform 310 generates, for each hour-interval in the one-week segment of time-series data, an anomaly score based on the difference between the predicted target utility usage value and the actual utility usage value. The meter monitoring platform 310 may identify particular anomalies as corresponding to equipment and/or transmission failures. For example, if a particular hour-interval corresponds to a period of extreme hot or cold weather and also a drop in power usage, the meter monitoring platform 310 may determine that an equipment failure has occurred, based on historical patterns associated with power usage and extreme weather conditions. As another example, if a sequence of hour-long intervals maintain a same power usage level when the system expects varying power usage levels, the meter monitoring platform 310 may determine a data transmission failure has occurred.

Based on detecting anomalous time-series data in the target time-series meter data 361, the anomaly remediation engine 315 may perform a remediation operation of using the predicted time-series values generated by the machine learning model 362 to replace anomalous time-series values. The meter monitoring platform 310 may use utility usage data for multiple different purposes, such as planning for future development of a utility network, predicting a load on a utility network, and billing customers for utility usage. When equipment failure, utility transmission failure, or meter data transmission failure interrupt a series of time-series data points with anomalous data points, systems may be unable to accurately plan for future development or bill customers. The anomaly remediation engine 315 remediates the detected anomalous values by replacing the values, in a data storage or data transmission, with values predicted by the machine learning model 362. According to one example, the meter monitoring platform 310 may detect three days of anomalous data points in a one-month segment of time series data. The meter monitoring platform 310 may replace the anomalous data point values in the time-series data with the target values generated by the machine learning model. The meter monitoring platform 310 may identify trends using the data set including the replaced data point values instead of the anomalous data point values. As another example, the utility billing platform 319 may replace monetary values corresponding to anomalous utility usage values with replacement monetary values corresponding to the utility usage values predicted by the machine learning model 362. The utility usage values predicted by the machine learning model 362 would be more likely than the anomalous measured utility usage values to reflect the actual utility usage. Accordingly, the utility billing platform 319 could bill a client an amount that more closely corresponds to the actual utility usage than the utility usage reflected in the anomalous data point values.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

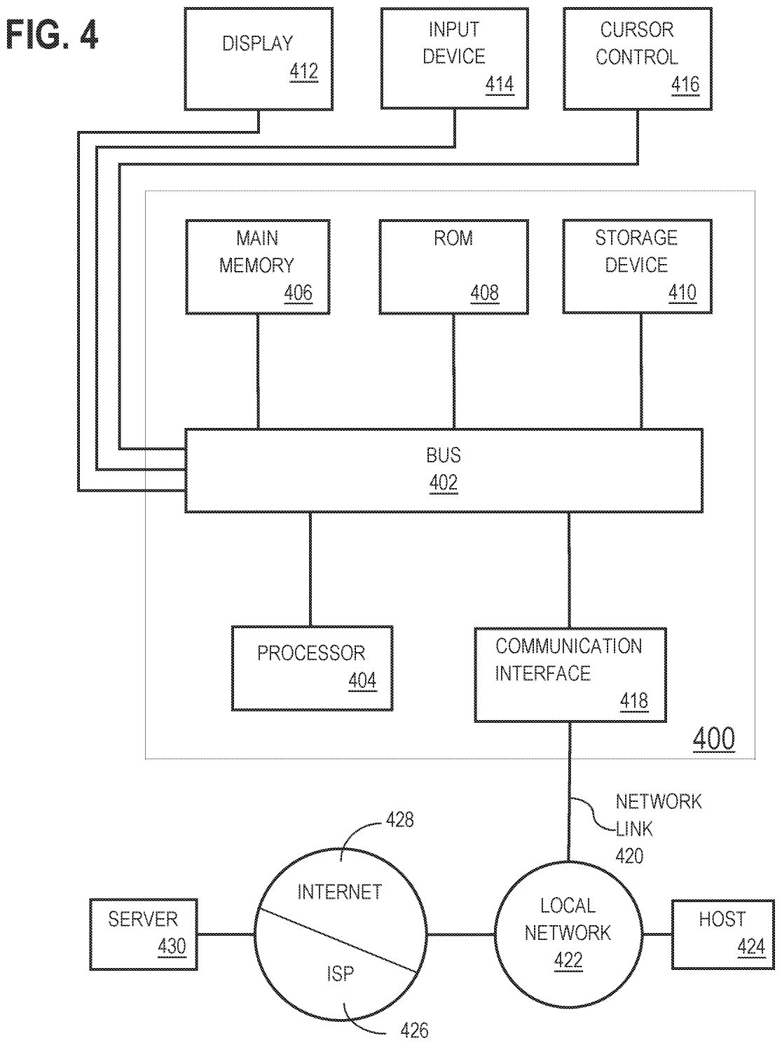

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
training a machine learning model to predict target operating values for monitored devices, the training comprising:
obtaining first subsets of training data comprising historical operating data for one or more monitored devices, each first subset of training data comprising:
time-series operating values for the one or more monitored devices; and
for each subset of the first subset of training data, a label identifying the subset as real operating data;
generating second subsets of training data at least by:
selecting the second subsets of training data from among the first subsets of training data;
applying noise to the second subsets of training data; and
for each subset of the second subsets of training data, applying a label identifying the subset as false operating data;
training the machine learning model based on the first subsets of training data and the second subsets of training data;
receiving particular time series operating data associated with a first monitored device;
applying the machine learning model to the particular time series operating data to generate predicted target operating data; and
comparing a first value of a first data point of the received particular time series operating data with a second value corresponding to a predicted target operating data value associated with the first data point; and
based on determining a difference between the first value and the second value exceeds a threshold, identifying the first value as anomalous.

2. The non-transitory computer readable medium of claim 1, wherein the operations further comprise:
comparing a third value of a second data point of the received particular time series operating data with a fourth value corresponding to a predicted target operating data value associated with the second data point;
based on determining a difference between the third value and the fourth value exceeds the threshold, identifying the third value as anomalous;
responsive to determining the difference between the first value and the second value exceeds the threshold by a first amount, assigning a first weight to the first value;
responsive to determining the difference between the third value and the fourth value exceeds the threshold by a second amount, assigning a second weight to the third value;
performing a remediation operation associated with the first value based on determining the first weight meets a remediation criteria; and
refraining from performing any remediation operation associated with the third value based on determining the second weight does not meet the remediation criteria.

3. The non-transitory computer readable medium of claim 1, wherein each first subset of training data further comprises attributes associated with the one or more monitored devices, the attributes including at least weather conditions in a vicinity of the one or more monitored devices.

4. The non-transitory computer readable medium of claim 3, wherein the attributes associated with the one or more monitored devices further include at least one of: temperature data, dewpoint data, dwelling type data, and demographic data.

5. The non-transitory computer readable medium of claim 1, wherein applying the noise to the second subsets of training data comprises:
selecting a set of data points from among the first subsets of training data;
randomly selecting an addition operation or a subtraction operation to be performed; and
based on the randomly selected addition or subtraction operation, applying a random positive variation or a random negative variation, within a threshold level of variation, to a value of each data points in the selected set of data points.

6. The non-transitory computer readable medium of claim 1, wherein receiving target time series operation data comprises:
receiving time series operation values and location data associated with the first monitored device;
based on the location data, identifying a weather sensor within a threshold distance of the first monitored device;
obtaining weather data generated by the weather sensor associated with the received time series operation values; and
generating vectors including the time series operation values and the weather data,
wherein the machine learning model is applied to the vectors.

7. The non-transitory computer readable medium of claim 1, wherein the machine learning model is based on a deep learning long short-term memory (LSTM) type model.

8. The non-transitory computer readable medium of claim 1, wherein the operations further comprise:
comparing a third value of a second data point of the received particular time series operating data with a fourth value corresponding to a predicted target operating data value associated with the second data point; and
based on determining a difference between the third value and the fourth value does not exceed the threshold, identifying the third value as non-anomalous.

9. The non-transitory computer readable medium of claim 1, wherein the operations further comprise:
based on operating values of the first monitored device over a defined period of time, associating a monetary value with a particular user account corresponding to the first monitored device; and
based on determining the first value of the first data point is anomalous: omitting from the monetary value associated with the particular user account a first monetary value associated with the first value of the first data point.

10. The non-transitory computer readable medium of claim 1, wherein the time series operating data comprises power data measured by a power utility meter at a particular location.

11. A method comprising:
training a machine learning model to predict target operating values for monitored devices, the training comprising:
obtaining first subsets of training data comprising historical operating data for one or more monitored devices, each first subset of training data comprising:
time-series operating values for the one or more monitored devices; and
for each subset of the first subset of training data, a label identifying the subset as real operating data;
generating second subsets of training data at least by:
selecting the second subsets of training data from among the first subsets of training data;
applying noise to the second subsets of training data; and
for each subset of the second subsets of training data, applying a label identifying the subset as false operating data;
training the machine learning model based on the first subsets of training data and the second subsets of training data;
receiving particular time series operating data associated with a first monitored device;
applying the machine learning model to the particular time series operating data to generate predicted target operating data; and
comparing a first value of a first data point of the received particular time series operating data with a second value corresponding to a predicted target operating data value associated with the first data point; and
based on determining a difference between the first value and the second value exceeds a threshold, identifying the first value as anomalous.

12. The method of claim 11, further comprising:
comparing a third value of a second data point of the received particular time series operating data with a fourth value corresponding to a predicted target operating data value associated with the second data point;
based on determining a difference between the third value and the fourth value exceeds the threshold, identifying the third value as anomalous;
responsive to determining the difference between the first value and the second value exceeds the threshold by a first amount, assigning a first weight to the first value;
responsive to determining the difference between the third value and the fourth value exceeds the threshold by a second amount, assigning a second weight to the third value;
performing a remediation operation associated with the first value based on determining the first weight meets a remediation criteria; and
refraining from performing any remediation operation associated with the third value based on determining the second weight does not meet the remediation criteria.

13. The method of claim 11, wherein each first subset of training data further comprises attributes associated with the one or more monitored devices, the attributes including at least weather conditions in a vicinity of the one or more monitored devices.

14. The method of claim 13, wherein the attributes associated with the one or more monitored devices further include at least one of: temperature data, dewpoint data, dwelling type data, and demographic data.

15. The method of claim 11, wherein applying the noise to the second subsets of training data comprises:
selecting a set of data points from among the first subsets of training data;
randomly selecting an addition operation or a subtraction operation to be performed; and
based on the randomly selected addition or subtraction operation, applying a random positive variation or a random negative variation, within a threshold level of variation, to a value of each data point of the selected set of data points.

16. The method of claim 11, wherein receiving target time series operation data comprises:
receiving time series operation values and location data associated with the first monitored device;
based on the location data, identifying a weather sensor within a threshold distance of the first monitored device;
obtaining weather data generated by the weather sensor associated with the received time series operation values; and
generating vectors including the time series operation values and the weather data,
wherein the machine learning model is applied to the vectors.

17. The method of claim 11, wherein the machine learning model is based on a deep learning long short-term memory (LSTM) type model.

18. The method of claim 11, further comprising:
comparing a third value of a second data point of the received particular time series operating data with a fourth value corresponding to a predicted target operating data value associated with the second data point; and
based on determining a difference between the third value and the fourth value does not exceed the threshold, identifying the third value as non-anomalous.

19. The method of claim 11, further comprising:
based on operating values of the first monitored device over a defined period of time, associating a monetary value with a particular user account corresponding to the first monitored device; and
based on determining the first value of the first data point is anomalous: omitting from the monetary value associated with the particular user account a first monetary value associated with the first value of the first data point.

20. A system comprising:
one or more processors; and
memory storing instructions that, when executed by the one or more processors, cause the system to perform:
training a machine learning model to predict target operating values for monitored devices, the training comprising:
obtaining first subsets of training data comprising historical operating data for one or more monitored devices, each first subset of training data comprising:
time-series operating values for the one or more monitored devices; and
for each subset of the first subset of training data, a label identifying the subset as real operating data;
generating second subsets of training data at least by:
selecting the second subsets of training data from among the first subsets of training data;
applying noise to the second subsets of training data; and
for each subset of the second subsets of training data, applying a label identifying the subset as false operating data;
training the machine learning model based on the first subsets of training data and the second subsets of training data;
receiving particular time series operating data associated with a first monitored device;
applying the machine learning model to the particular time series operating data to generate predicted target operating data; and
comparing a first value of a first data point of the received particular time series operating data with a second value corresponding to a predicted target operating data value associated with the first data point; and
based on determining a difference between the first value and the second value
exceeds a threshold, identifying the first value as anomalous.
